(19) United States
(12) Patent Application Publication
(10) Pub. No.: US 2009/0047235 A1
(43) Pub. Date: Feb. 19, 2009

(54) Paratransgenesis to Control Termites or Other Social Insects

(76) Inventors: Claudia R. Husseneder, St. Gabriel, LA (US); James A. Ottea, Baton Rouge, LA (US); Lane D. Foil, Baton Rouge, LA (US); Frederick M. Enright, Baton Rouge, LA (US); Richard K. Cooper, Baton Rouge, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 12/120,717

(22) Filed: May 15, 2008

Related U.S. Application Data
(60) Provisional application No. 60/938,502, filed on May 17, 2007.

(51) Int. Cl. A01N 25/00; A01N 63/04

(52) U.S. Cl. 424/84; 424/93.21

(57) ABSTRACT

A paratransgenesis system is disclosed to kill targeted social insects such as termites and cockroaches, for example the Formosan subterranean termite. A genetically modified yeast can be effectively used to express and deliver lytic peptides directly within the termite gut. Some highly lytic peptides directly damage the insect gut itself, leading to the death of the insect within about three days. Other lytic peptides kill all (or at least most) species of protozoa in the termite gut. The protozoa provide wood-digesting enzymes (cellulases) to the termite. Without these protozoa (and their cellulases) the insect dies within about six weeks. The system is completely free from conventional neurotoxins and other organic pesticides.

The benefit of the May 17, 2007 filing date of U.S. provisional patent application 60/938,502 is claimed under 35 U.S.C. §119(e).

The development of this invention was partially funded by the United States Government under SERDP Project No. 06 CSSEED01-005/SI-1467 awarded by the Department of Defense. The United States Government has certain rights in this invention.

This invention pertains to the control of colonial or social insects, such as termites and cockroaches.

Subterranean termites are one of the most destructive and costly insect pest species. Annual economic losses due to the Formosan subterranean termite (Coptotermes formosanus Shiraki, or “FST”) are in the billions of dollars worldwide. There is increasing demand for the development of new, environmentally-friendly, rapidly-acting, and cost-effective termite control technologies, that preferably do not require the use of synthetic pesticides.

Most prior methods of controlling termites have relied upon the use of synthetic pesticides, either applied indiscriminately, or in a targeted fashion, or via bait stations. Synthetic insecticides (most of which are nerve toxins) are associated with risks of environmental contamination, non-target effects, and the development of insecticide resistance. In addition, today's insecticides have short half-lives (i.e., their efficacies decrease rapidly over time). There is an unfilled demand for reduced-risk, environmentally friendly techniques that are effective for controlling termites.

There are relatively few reported methods for controlling termites without the use of synthetic pesticides, and none have been widely adopted. Prior, non-pesticide methods have included liquid nitrogen, heat, microwaves, or high voltage, but these methods have met with only limited success.

Most (if not all) insects harbor a variety of gut symbionts (primarily protozoa and bacteria), upon which they depend for survival. Wood-feeding termites and cockroaches rely on gut symbionts for cellulose digestion, nitrogen fixation, acetate production (energy), and vitamin production. Among the symbionts of the Formosan subterranean termite are three species of flagellate protozoa (Pseudotrichonympha grassii Koidzumi, Holomastigotoidesi hartmanni Koidzumi, Spirotrichonympha leidyi Koidzumi), which assist termites in degrading and digesting wood and cellulose efficiently.

If the gut flora are destroyed, a termite can die of “starvation,” even in the presence of an abundance of food. “Paratransgenesis” is the genetic engineering of a symbiont, and can be used as an indirect way of controlling the host organism. Paratransgenesis of gut bacteria has previously been explored as a vehicle to control termites. Previous studies have demonstrated the principle of paratransgenesis, using modified bacteria. For example, in one study the bacterium Enterobacter cloacae was isolated from the gut of the Formosan subterranean termite, and genetically engineered to express a reporter gene, green fluorescent protein (GFP). This bacterium was rapidly transferred among workers and soldiers in laboratory colonies. See C. Husseneder et al., “Use of genetically engineered bacteria (Escherichia coli) to monitor ingestion, loss and transfer of bacteria in termites,” Current Microbiology, vol. 50, pp. 119-123 (2005); and C. Husseneder et al., “Genetically engineered termite gut bacteria deliver and transfer foreign genes in termite colonies,” Applied Microbiology and Biotechnology, vol. 68, pp. 360-267 (2005); and U.S. Pat. No. 6,926,889.

Lytic peptides are known to be toxic against a variety of bacteria and protozoans. Lytic peptides generally do not harm normal eukaryotic cells, however, which are better able to repair the damage that lytic peptides inflict on cell membranes. Some highly lytic peptides, such as melittin and Phor21, will indiscriminately kill both prokaryotic and eukaryotic cells.

Lytic peptides have been reported to have in vitro and in vivo effects against protozoal pathogens. See, e.g., J. Jaynes et al., “In vitro cytocidal effect of novel lytic peptides on Plasmodium falciparum and Trypanosoma cruzi,” FASEB J., vol. 2, pp. 2878-2883 (1988); G. Mutwiri et al., “Effect of the Antimicrobial Peptide, D-Hecate, on Trichomonads,” J. Parasitol., vol. 86, pp. 1355-1359 (2000); and S. Barr et al., “Activity of lytic peptides against intracellular Trypanosoma cruzi amastigotes in vitro and parasitemias in mice,” J. Parasitol., vol. 81, pp. 974-978 (1995).

T. Hierath et al., “An evaluation of lytic peptides as a termiticide,” poster presentation, Louisiana State University Summer Undergraduate Research Forum (2002) reported preliminary data that the lytic peptides agni, gagni, pagni and hecate would kill termite symbiotic protozoa when administered in vitro. However, no mortality was observed when the lytic peptides were fed directly to termites. Possible explanations were that the termites did not consume sufficient doses of the peptides, or the peptides were inactivated by termite digestive processes (unpublished data).

We have discovered a paratransgenesis-like system to kill targeted colonial or social insects such as termites and cockroaches, for example the Formosan subterranean termite. Surprisingly, we found that genetically modified yeast can be effectively used to express and deliver lytic peptides directly within the termite gut. Some highly lytic peptides, such as melittin, directly damage the insect gut itself, leading to the death of the insect within about three days. Other lytic peptides, such as hecate, agni, and gagni kill all (or at least most) species of protozoa in the termite gut. The protozoa provide wood-digesting enzymes (cellulases) for the termite. Without these protozoa (and their cellulases) the insect dies within about six weeks. Initial embodiments have been successfully tested. The novel system is completely free from conventional neurotoxins and other organic pesticides.

The success of the novel system was particularly surprising, since it is based upon genetically engineered yeast. Termites are not known to consume yeast in appreciable amounts, nor to harbor any yeast symbionts. Thus it was surprising that termites would not only consume filter paper or liquid droplets containing the engineered yeast, but that the yeast would survive within the termite gut and express and secrete lytic peptide long enough to kill the termite. Additionally (based on prior experiments with GFP-transformed Enterobacter), we expect that the termites will spread the “Trojan Horse” yeast to other colony members by trophallaxis.

Paratransgenesis: constructing the enemy within. “Paratransgenesis” is the genetic manipulation of a host's symbiotic microorganisms to achieve any of several objectives, ranging from disease eradication to control of the host organism (pest control). The application of paratransgenesis to social insects is promising because social interactions promote the exchange of microbes between colony members by feeding or grooming. Termites have a close relationship with a number of microbial symbionts. The hindgut of the Formosan subterranean termite provides houses an array of protozoa and bacteria that fulfill important functions for their hosts, beginning with cellulose digestion. These symbionts are potential tools and targets for paratransgenesis in the control of FST.

However, while similarities exist, the present invention does not actually rely upon paratransgenesis per se, as that term is generally understood. The present invention does not rely upon genetic manipulation of any naturally-occurring symbiont. Rather, it is based on a genetically modified organism (yeast) that is not a symbiont of the target organism (termite, cockroach, or other social insect). The yeast are engineered to secrete peptide toxins that target and kill the host's symbiotic protozoa, bacteria, or both. It was surprising that we could successfully achieve this goal using yeast that are not known to be specific or even native to termites. Without their obligate protozoa the insects die. An alternative embodiment is to engineer yeast to produce toxins that act directly against cells of the insect gut.

The yeast-based system avoids digestion of lytic peptides in the digestive tract of the termite that can occur if the termites are simply fed the peptides. The novel system provides a self-sustaining delivery system that will easily spread through a termite colony. Termites that were fed for 24 h with yeast expressing hecate lost their gut flora within four weeks, and subsequently died. To our knowledge, this is the first reported instance of using an engineered yeast, or indeed any eukaryote, in such a manner to kill termites or other insects.

Other insects that rely on endosymbionts for survival may be targeted in a similar fashion, particularly other social insects, for example other species of termites, and species of cockroaches, and possibly some species of ants. For example, like termites, cockroaches also have gut endosymbionts that digest cellulose. Even for insects that lack obligate symbionts, the gut can be targeted directly by yeast that express melittin or other highly lytic peptides.

Bait systems may be used to introduce the engineered yeast to the targeted pest species. Social interactions spread the yeast among colony members, and reduce or eliminate the colony. Non-social insects may also be targeted on an individual basis with baits.

The novel system has major advantages over conventional forms of pest control. It offers an effective, environmentally-friendly alternative to traditional means of control with organic pesticides. The rate of expression of the lytic peptide gene product, and thus the speed of action, can be selected by appropriate choice of promoters. Genes encoding multiple lytic peptides may be inserted into the yeast to inhibit the development of resistance, and to enhance effects against the target organisms.

In initial tests, lytic peptides successfully killed termite gut protozoa under both aerobic and anaerobic conditions. In further initial experiments, a microinjection system was developed to test lytic peptide activity in the termite gut in vivo. Small volumes (˜0.5 μl) of different lytic peptide solutions were injected into the hindgut of termite workers. Following injection of the lytic peptides hecate and melittin, defaunation of injected termite workers was observed at 72 hrs. A separate experiment in which termite workers were fed the anti-protozoal drug metronidazole (Flagyl), confirmed that defaunation led to termite death after six weeks. The lytic peptides hecate and melittin were then used to construct a prototype paratransgenesis system to demonstrate that the yeast paratransgenesis system will successfully kill termites.

The host selected for the prototype experiments was the commercially available yeast Kluyveromyces lactis. In preliminary experiments, fluorescence-labeled yeast were fed to termites in a bait; and the yeast were subsequently detected in worker hindguts by fluorescence microscopy, showing that the yeast could be taken up by termites and survive in the hindgut. Expression cassettes for melittin and hecate were codon-optimized for expression in the yeast, and the codon-optimized DNA sequences were then commercially synthesized. Those sequences were cloned into K. lactis, and expression of active lytic peptide was confirmed by observing the death of T. pyriformis laboratory cultures treated with supernatant from the yeast culture.

When termite workers were fed the lytic peptide-expressing yeast, their guts were defaunated within 4 weeks, with death following soon afterwards.

We observed, however, that the “killer” yeast strains lost their ability to express lytic peptide two months after the initial confirmation of their toxicity, apparently due to DNA recombination events. This loss, although unexpected, actually increases environmental safety for genetically modified yeast.

To avoid premature loss of expression, the yeast stocks may be lyophilized. Alternatively, selection pressure may be maintained in the laboratory by periodically adding to the yeast culture a bacterial pathogen that otherwise attacks yeast, but that is itself killed by the secreted lytic peptide. Another alternative is to engineer the yeast with another trait such as antibiotic resistance, heavy metal tolerance, or the like, tightly linked to a lytic-peptide encoding sequence, and to regularly apply the appropriate selective pressure to the culture to maintain the exogenous DNA sequence in the laboratory.

Not only are the engineered yeast not well-suited to survive long in the environment, but the yeast are not pathogenic to humans any other vertebrates in any case. Additional safety may derive from using one of the many lytic peptides that are relatively non-toxic to vertebrates; and the fact that a termite colony is comparatively “contained”; trophallaxis within a colony does not imply transfer to individuals outside the colony.

Additional safety features may optionally be used, such as linking the sequence encoding the toxin to an inducible promoter, where the inducer is one that will not commonly be found in the environment, allowing the spread of the yeast throughout the colony; and then administering the inducer to the colony. Examples of such inducers are well-known and include, for example promoters that are inducible by tetracycline, and metallothionein-derived promoters that are responsive to metals such as copper or zinc.

### EXAMPLE 1

### Construction of Lytic-Peptide Producing Yeast

A commercially-available yeast expression system based on Kluyveromyces lactis (New England Biolabs) was chosen for a prototype embodiment of the invention. This yeast was found to be relatively resistant to lytic peptide toxicity, and it could be successfully introduced into the termite gut by feeding or drinking.

Genes for lytic peptides were synthesized and ligated into the plasmid pKLAC for integration into the yeast chromosome. Prototype examples employed a hecate or a hecate-GFP fusion coding sequence.

### EXAMPLE 2

### Construction of the Hecate Fusion Gene, and Transformation of Yeast

The hecate amino acid sequence is available on the internet at NCBI in the Protein database

(SEQ ID NO 1)

Hecate amino acid sequence: falalkalkk alkklkkalk
kal
http://www.ncbi.nlm.nih.gov/entrez/viewer.fcgi?db=
protein&val=1703731

A hecate coding sequence was produced by using freeware programs from the ExPASy website (http://www.bioinformatics.org/sms2/rev_trans.html), and was then codon-optimized by Genscript for expression in yeast.

Codon-optimized hecate coding sequence:

(SEQ ID NO 2)

TTT GCT TTG GCT TTG AAG GCT TTG AAG AAA GCA TTG
AAA AAG TTG AAA AAG GCT CTG AAA AAG GCT TTA

To clone the coding sequence into the chosen vector system (the K. lactis expression system), and to secrete the protein of interest from the yeast host, additional DNA sequences were added to the 5′ and 3′ ends of the hecate gene:

| | |
|---|---|
| 5′ ctc gag aaa aga | (SEQ ID NO 3) |
| taa aga tct cgc 3′ | (SEQ ID NO 4) |

The hecate gene was then synthesized by Genscript (www.genscript.com):

(SEQ ID NO 5)

CGCCTCGAGAAAAGA TTT GCT TTG GCT TTG AAG GCT TTG
AAG AAA GCA TTG AAA AAG TTG AAA AAG GCT CTG AAA
AAG GCT TTA TAAAGATCTCGC

Additionally, a hecate-GFP fusion gene was also synthesized by Genscript:

(SEQ ID NO 6)

CGCCTCGAGAAAAGA TTT GCG CTG GCT CTG AAA GCG CTG
AAA AAA GCA CTG AAA AAA CTG AAA AAA GCC CTG AAA
AAG GCT CTG ATGAGCAAAGGTGAAGAACTGTTCACAGGGGTGGT
TCCGATTCTGGTGGAACTGGATGGCGATGTGAACGGTCATAAATTTA
GCGTTAGCGGTGAAGGTGAAGGCGACGCGACATACGGCAAACTGACA
CTGAAGTTTATTTGCACGACCGGCAAACTGCCAGTTCCGTGGCCAAC
ACTGGTCACGACATTTGGTTACGGCGTACAGTGCTTCGCGCGTTATC
CTGACCATATGAAACAGCATGATTTCTTTAAAAGTGCTATGCCTGAG
GGTTATGTGCAGGAACGTACCATTTTCTTTAAAGACGACGGTAACTA
TAAAACCCGTGCGGAAGTCAAATTCGAGGGTGATACGCTGGTTAACC
GCATTGAACTGAAAGGAATTGATTTCAAAGAAGATGGCAATATTCTG
GGTCACAAACTGGAGTATAATTATAACAGCCATAATGTTTATATTAT
GGCAGATAAACAGAAAAACGGTATCAAAGTGAACTTCAAAATTCGTC
ACAACATCGAAGATGGGTCAGTGCAGCTGGCAGATCATTATCAGCAG
AACACGCCAATTGGCGACGGCCCGGTCCTGCTGCCTGATAACCATTA
TCTGTCTACTCAGAGCGCGCTGAGCAAAGATCCTAATGAAAAACGCG
ATCATATGGTCCTGCTGGAATTTGTCACCGCCGCAGGCATTACACAC
GGCATGGATGAACTGTACAAA TAAAGATCTCGC

The hecate-GFP fusion construct was inserted into the yeast vector in accordance with manufacturer's recommended protocols (a copy of which were copied in and may be viewed as pp. 169-191 of provisional priority application 60/938,502, hereby incorporated by reference).

### EXAMPLES 3 and 4

### Bioassays

The biological activity of secretions from the engineered yeast strains was tested in vitro against the protozoan Tetrahymena pyriformis. Yeast was grown 72 h, and 50 μL supernatant was transferred to microwells containing 50 μL protozoa culture. The numbers of protozoa were counted after 72 h in each assay, and statistical analyses were conducted with SAS Proc Mixed ANOVA (Tukey's mean separation). The genetically engineered yeast expressed sufficient hecate to significantly reduce the number of viable protozoa as compared to controls.

### EXAMPLE 5

### Tetrahymena pyriformis Cultures

The initial positive control for testing the efficacy of lytic peptide solutions was the aerobic, laboratory standard protozoan Tetrahymena pyriformis, cultures of which were purchased from Carolina Biological (#13-1182A) and maintained in proteose peptone media. Before each experiment, lytic peptide activity was tested using T. pyriformis.

### EXAMPLE 6

### Establishing Protozoal Cultures from the Termite Hindgut, and Testing the Effects of Lytic Peptide on those Protozoa

Three protozoal species (Pseudotrichonympha grassii Koidzumi, Holomastigotoides hartmanni Koidzumi, and Spirotrichonympha leidyi Koidzumi) from the termite hindgut were maintained for 24 hrs in vitro, a sufficient time to allow testing of lytic peptides. The protozoa were removed from the termite hindgut in an anaerobic glove-box, and placed in sterile, sparged (Hydrogen 2.5%, Carbon dioxide 5% and Nitrogen 92.5%) Trager U (pH 7.0) saline solution. Positive controls for testing lytic peptides were established and validated with these cultures. The efficacy of the lytic peptides was then routinely tested prior to experiments to confirm both aerobic activity (using the “standard” T. pyriformis) and anaerobic activity (using cultures of the termite protozoa). One hundred percent mortality was observed after 5-10 minutes when any of these protozoa were treated with any one of three lytic peptides (hecate, melittin, or cecropin) at a 50 μM concentration, confirming the toxicity of the lytic peptides towards termite protozoa in an anaerobic environment that mimicked termite hindgut conditions.

### EXAMPLE 7

### Determining the Effects of Defaunation on Termites, Using Metronidazole

Using an aspirator, six groups of 100 termite workers each were collected and placed in Petri dishes containing damp filter paper. In addition, 10 soldiers were added to each group to enhance the overall survivorship rate. Three of the groups were transferred to Petri dishes containing filter paper that had previously been treated with 400 μL Metronidazole (2 g/L), which possesses activity against both anaerobic bacteria and protozoa. The remaining three groups of termites were transferred to Petri dishes containing paper that had been dampened with autoclaved tap water. All six replicates were transferred to an incubator and mortality was recorded every 24 hours. After seven days, five workers were removed from each group; their guts were extirpated; and the presence or absence of protozoa was observed with a light microscope. Once defaunation had been confirmed, all six groups were thereafter provided only with filter paper dampened with sterile tap water. Mortality was recorded each day. Statistically significant differences in mortality between treatment groups and control groups were established using 95% confidence intervals.

Defaunation of termite workers was observed within 7 days of feeding with Metronidazole. The defaunated termites died within six weeks. The untreated termites were not defaunated and had not died after six weeks (data not shown). Confidence intervals of 95% did not overlap, indicating significantly higher mortality of defaunated termites versus controls.

### EXAMPLE 8

### Initial Evaluation of Lytic Peptides

Lytic peptides will adsorb to charged surfaces, e.g., to glass and to many polymers. This adsorption can reduce the apparent efficacy of a lytic peptide solution in vitro. To minimize such effects, Sigmacote™ (Sigma, # SL-2) was used to treat all glass and polymer surfaces prior to contact with lytic peptides. Sigmacote™ reacts with surface silanol groups on glass to produce a neutral, hydrophobic, microscopically thin surface film. This neutral film inhibits adsorption of basic proteins, such as lytic peptide, onto the surface of the glass.

The efficacy of each lytic peptide solution was confirmed using T. pyriformis and termite protozoa cultures in vitro before each microinjection test. A 5 ml overnight culture of T. pyriformis was washed three times in sterile 10 mM Tris-HCl (pH 7.4), and suspended in 1 ml 10 mM Tris-HCl (pH 7.4). Subsequently, 100 μl aliquots were placed in a Sigmacote™-treated, 96-well microplate. The lytic peptides were dissolved in 10 mM Tris-HCl. A range of concentrations (25-500 μM) of lytic peptide was added to each of several wells, and the remaining wells were treated with 10 mM Tris-HCl (pH 7.4) as control. After confirming aerobic activity of the lytic peptide concentrations against T. pyriformis, lytic peptide efficacy was then tested against anaerobic cultures of termite protozoa. Sparged lytic peptide was added anaerobically to the sparged cultures of termite protozoa, and mortality was observed.

### EXAMPLE 8

### Direct Delivery of Lytic Peptides to Termites by In Vivo Microinjection

A termite microinjection protocol was used to confirm directly the effect of lytic peptide in the hindgut. We first optimized the protocol by finding preferred conditions for each of the following: the time to immobilize a termite by cooling on ice; suitable methods for anchoring the termite in place for microinjection; and the maximum volume that could consistently be injected into the hindgut without causing direct trauma. Microinjection directly to the termite hindgut avoided the possibility of peptide degradation by non-specific protease activity in the foregut or midgut.

Termite workers were immobilized by chilling on ice for 1.5 min, and were then mechanically aspirated, head-first, into a modified pipette tip that had been trimmed to expose the terminus of the termite. This “termite holder” was attached to a micromanipulator, and the insect was advanced to insert a Sigmacote™-treated, fine glass needle into the anus of the termite. Lytic peptide or control solution was injected under the control of a high-speed, electronic foot pedal with pulse length control, to ensure that a constant volume was reproducibly injected into each insect. Approximately 0.5 μl of 10 mM Tris-HCl (pH 7.4) (control) or 0.5 μl of 50 μM lytic peptide dissolved in 10 mM Tris-HCl (pH 7.4) was injected into the hindgut of each termite. A second control group of non-injected termite workers was also included. The termites were housed in 3 cm Petri dishes, in which damp filter paper was provided. At 24, 48, and 72 hrs guts from randomly selected termites from each treatment were extirpated, and observations were made of the presence and motility of protozoa.

We observed that microinjection with 50 μM concentrations of the lytic peptides consistently defaunated the termites within 72 hours. The observed protozoicidal effects occurred more slowly than in the in vitro assays, ˜72 hrs vs. ˜5-10 minutes, probably because the volume of solution injected into the hindgut was limited to ˜0.5 μl. Of the peptides tested, the more effective against protozoa in vivo were hecate and melittin.

### EXAMPLE 9

### Development of the Vector System

A prototype peptide expression and secretion system was prepared and demonstrated using a commercially-available, yeast-based expression system based on Kluyveromyces lactis (#E1000S) from New England BioLabs (NEB). The coding sequence of interest was inserted into the yeast genome following the manufacturer's recommended protocols, and the peptide was expressed as a pro-form. The pro-peptide was cleaved by internal cell mechanisms, and the active peptide was secreted into the growth media.

Melittin and hecate were selected for these transformations based on their efficacy in the hindgut microinjection experiments. Melittin (78 bp) and hecate (69 bp) coding sequences were codon-optimized for expression in K. lactis by Genscript Ltd. (http://www.genscript.com). Fusion coding sequences encoding lytic peptide fused to green fluorescent protein were also codon-optimized. The coding sequences were synthesized commercially by Genscript (www.genscript.com), cloned into a plasmid (pUC 57), and shipped in lyophilized form. The plasmids were re-suspended in sterile water and used in accordance with NEB's K. lactis protein expression kit manual to produce lytic peptide-expressing yeast strains. Integration of the exogenous coding sequences was confirmed in accordance with the manufacturer's protocols. Transformation of the K. lactis with the vector plus the coding sequence of interest was confirmed by the growth of K. lactis on the manufacturer's recommended growth media, containing acetamide as the only nitrogen source, and was further confirmed by PCR using the supplier's PCR primers.

### EXAMPLE 10

### Control Yeast Strains

Control strains of K. lactis were also prepared in a generally similar manner, but engineered to express the nontoxic maltose binding protein (MBP). Secretion of the MBP control protein was confirmed through a Western blot protocol supplied by the manufacturer.

### EXAMPLE 11

### Tetrahymena/Yeast Toxin Activity Assay

The lytic peptide-expressing and control K. lactis yeast strains were separately grown in 2 ml of YPGal, in Sigmacote™-treated (Sigma-Aldrich #SL2) tubes for 2-3 days at 30° C., with shaking at 225 rpm. In the meantime, a 15 ml glass tube with 5 ml Proteose Peptone media was used to grow a culture of T. pyriformis, incubated at 30° C. with shaking at 100 rpm overnight. A 1 ml aliquot of the overnight culture was then added to 50 ml of YPGal, and incubated at 30° C. with shaking at 100 rpm overnight to increase the number of T. pyriformis. After three days the yeast cultures were centrifuged, and the supernatant was retained for use in the assay. A Sigmacote™-treated, 96-well cell culture plate was prepared with 50 μl of T. pyriformis culture in each well. An equal volume of the yeast supernatant was gently mixed into each well. Extra wells of T. pyriformis without supernatant treatment were set up as additional controls, and also for taking an initial cell count. Cells were counted using a Hemocytometer at 0, 24, 48, and 72 hrs. Statistical analysis was performed with the SAS Proc Mixed ANOVA model, with Tukey's mean separation.

### EXAMPLE 12

### Termite Feeding Experiments with Green Fluorescent Protein-Labeled Yeast

A termite feeding assay with green fluorescent protein-labeled yeast (non-lethal, fluorescent yeast vacuole stain MDY-64, Sigma) was used to answer the basic question whether yeast could successfully enter and persist in the hindgut of termite workers. To the inventors' knowledge, the answer to even this basic question was previously unknown. Yeast are not known to be significant termite symbionts, nor to constitute a significant part of the termite diet. Yeast are not known to contain cellulose, cellulases, nor any other components that would appear to make them likely candidates for the termite diet or for symbiosis. Twenty droplets of “stained” yeast were dispensed in a circular pattern in a clean Petri dish; a control dish was prepared with water droplets. Twenty termite workers were placed in each dish. After 1 hour termite guts were extirpated from each treatment, and the presence of labeled yeast was determined by fluorescence microscopy.

### EXAMPLE 13

### Termite Feeding Experiments with Yeast Expressing Lytic Peptide

Lytic peptide-expressing and control Kluyveromyces lactis strains were used in termite feeding experiments. Aliquots of 2 ml YPGal in Sigmacote™-treated 15 ml Falcon tubes were inoculated with yeast, which were then grown for 3 days, with shaking at 225 rpm at 30° C. The strains grown were K. lactis engineered with the expression vector (control), K. lactis expressing the control protein MBP, and K. lactis expressing a lytic peptide gene (either hecate or hecate-GFP fusion). The cultures were washed three times with sterile, deionized water, and re-suspended in 500 μl sterile 10 mM galactose. Galactose was used because the coding sequences were under the control of the LAC4 promoter, a strong promoter whose activity is induced by galactose. Secretion of active lytic peptide by the transformed K. lactis into the growth media was verified using in vitro cultures of the protozoa T. pyriformis. Supernatant from the growth media of each of two strains of K. lactis, one engineered to secrete Hecate and the other Hecate-GFP, contained sufficient levels of the peptide to cause significantly higher in vitro mortality of T. pyriformis at 72 hrs than control.

Termites were collected in New Orleans, La., and were maintained on damp cardboard in plastic buckets at room temperature. Only termites that had been held in the laboratory less than 4 weeks were used in the feeding experiments. Prior to the feeding experiments, a representative sample of termites were dissected and their guts were observed to confirm the health of the native termite protozoa. Once a termite colony's guts had been confirmed as being healthy, 28 groups, each containing 50 workers and 5 soldiers, were collected with aspirators. The groups were temporarily housed in Petri dishes on damp tissue paper covered with aluminum foil. In separate, clean, labeled Petri dishes, 20 distinct 2 μl droplets of the assigned yeast or control treatment were dispensed in a circular pattern. There were four replicates for each of six treatments: (1) hecate-expressing K. lactis; (2) hecate-GFP expressing K. lactis; (3) MBP-expressing K. lactis; (4) non-expressing K. lactis (vector only); (5) 10 mM galactose; or (6) sterile water. The groups of termites were randomly assigned to treatment dishes, where they were gently transferred to the centers with a soft paintbrush. The dishes housing the termites were placed on damp tissue paper and covered with aluminum foil for 24 hrs. The next day all groups were transferred to correspondingly labeled, clean, new Petri dishes and were provided with filter paper dampened with 10 mM galactose. Four of the eight sterile dH₂O treatment dishes were provided with sterile dH₂O dampened filter paper without galactose to control for any effect of the galactose itself upon termites.

Termite mortality was recorded every three days. The number of viable termites was also recorded, as cannibalism in laboratory colonies has sometimes been observed. Once per week termite guts were extirpated from two termites in each Petri dish, and the activity and the presence or absence of protozoa species were observed. For the duration of the experiment the termites in the Petri dishes were maintained on damp tissue paper and covered with aluminum foil. Differences in mortality were considered significant if the 95% confidence intervals did not overlap.

In the initial feeding experiments, termites that had been fed the experimental yeast strains (those expressing lytic peptide) were defaunated after four weeks, and died after six weeks. By contrast, defaunation was not observed in the controls. From the experiments described in Example 7, we know that defaunated termites (metronidazole) will die within about six weeks.

### EXAMPLE 13

### Termite Feeding Experiments with Yeast Expressing Lytic Peptide

However, when the feeding experiments were repeated four weeks later, mortality in termites treated with lytic peptide-expressing yeast was not significantly higher than that for control.

We then replicated the feeding experiment with a different termite colony. No defaunation was observed, contrary to the initial results. Similarly, re-testing of supernatant from the previously confirmed “killer-yeast-strains” on T. pyriformis cultures no longer led to protozoal death.

It appeared that the “killer” strains were no longer expressing active lytic peptide by ˜8 weeks after initial confirmation of lytic peptide toxicity. Several failed repetitions of the PCR amplification then followed. We concluded that recombination event(s) had likely caused the loss of lytic peptide expression. Although tolerance of K. lactis against lytic peptide in the media had been established prior to selecting this yeast as a microbial host, expressing and secreting the lytic peptide evidently placed selective pressure on the yeast to discard the exogenous sequence. While this loss of expression was surprising, it is actually an advantage in limiting the potential environmental impact of the engineered yeast.

The effect of the recombination can be mitigated by lyophilization of the yeast stocks during storage, and other alternative techniques as previously described.

Miscellaneous. The results reported here were surprising. The yeast used in these feeding experiments is not known to be a native termite symbiont, nor a food source for termites. Therefore it was surprising that the engineered yeast could be successfully used to kill termites in this manner. However, now that the invention has been successfully demonstrated in the prototype yeast system, it will hereafter be the case that prior disclosures concerning the use of bacteria to control insects in an analogous manner may be extrapolated for use with yeast, where otherwise applicable. For example, the bacterial-based methods of U.S. Pat. No. 6,926,889, the complete disclosure of which is hereby incorporated by reference, may be adapted for use with yeast, mutatis mutandis.

Lytic Peptides Useful in the Present Invention

Lytic peptides are particularly beneficial in practicing this invention, although the invention may also be practiced with other peptide toxins, any of the many toxins known in the art that may be encoded in DNA and expressed as an active toxin, pro-toxin, pre-toxin, or pre-pro-toxin. The toxin coding sequence may be placed under the control of any of the many constitutive or inducible promoters known in the art. A discussion of exemplary lytic peptides that may be used in this invention appears below. Lytic peptides are particularly preferred because of their low toxicity to mammals, to other vertebrates, and to other higher eukaryotes.

It is believed (without wishing to be bound by this theory) that cationic amphipathic peptides act by disrupting negatively-charged cell membranes. It is believed that tumor cells tend to have negatively-charged membranes, compared to more neutral membranes for normal eukaryotic cells, and are thus more susceptible to disruption by cationic amphipathic peptides.

The so-called Phor peptides, for example, are disclosed in M. Javadpour et al., “Self Assembly of Designed Antimicrobial Peptides in Solution and Micelles,” Biochem., vol. 36, pp. 9540-9549 (1997). Many lytic peptides are known in the art and include, for example, those mentioned in the references cited in the following discussion.

Lytic peptides are small, cationic peptides. Native lytic peptides appear to be major components of the antimicrobial defense systems of a number of animal species, including those of insects, amphibians, and mammals. They typically comprise 23-39 amino acids, although they can be smaller. They have the potential for forming amphipathic alpha-helices. See Boman et al., “Humoral immunity in Cecropia pupae,” Curr. Top. Microbiol. Immunol. vol. 94/95, pp. 75-91 (1981); Boman et al., “Cell-free immunity in insects,” Annu. Rev. Microbiol., vol. 41, pp. 103-126 (1987); Zasloff, “Magainins, a class of antimicrobial peptides from Xenopus skin: isolation, characterization of two active forms, and partial DNA sequence of a precursor,” Proc. Natl. Acad. Sci. USA, vol. 84, pp. 3628-3632 (1987); Ganz et al., “Defensins natural peptide antibiotics of human neutrophils,” J. Clin. Invest., vol. 76, pp. 1427-1435 (1985); and Lee et al., “Antibacterial peptides from pig intestine: isolation of a mammalian cecropin,” Proc. Natl. Acad. Sci. USA, vol. 86, pp. 9159-9162 (1989).

Known amino acid sequences for lytic peptides may be modified to create new peptides that would also be expected to have lytic activity by substitutions of amino acid residues that promote alpha-helical stability and that preserve the amphipathic nature of the peptides (e.g., replacing a polar residue with another polar residue, or a non-polar residue with another non-polar residue, etc.); by substitutions that preserve the charge distribution (e.g., replacing an acidic residue with another acidic residue, or a basic residue with another basic residue, etc.); or by lengthening or shortening the amino acid sequence while preserving its amphipathic character or its charge distribution. Lytic peptides and their sequences are disclosed in Yamada et al., “Production of recombinant sarcotoxin IA in Bombyx mori cells,” Biochem. J., vol. 272, pp. 633-666 (1990); Taniai et al., “Isolation and nucleotide sequence of cecropin B cDNA clones from the silkworm, Bombyx mori,” Biochimica Et Biophysica Acta, vol. 1132, pp. 203-206 (1992); Boman et al., “Antibacterial and antimalarial properties of peptides that are cecropin-melittin hybrids,” Febs Letters, vol. 259, pp. 103-106 (1989); Tessier et al., “Enhanced secretion from insect cells of a foreign protein fused to the honeybee melittin signal peptide,” Gene, vol. 98, pp. 177-183 (1991); Blondelle et al., “Hemolytic and antimicrobial activities of the twenty-four individual omission analogs of melittin,” Biochemistry, vol. 30, pp. 4671-4678 (1991); Andreu et al., “Shortened cecropin A-melittin hybrids. Significant size reduction retains potent antibiotic activity,” Febs Letters, vol. 296, pp. 190-194 (1992); Macias et al., “Bactericidal activity of magainin 2: use of lipopolysaccharide mutants,” Can. J. Microbiol., vol. 36, pp. 582-584 (1990); Rana et al., “Interactions between magainin-2 and Salmonella typhimurium outer membranes: effect of Lipopolysaccharide structure,” Biochemistry, vol. 30, pp. 5858-5866 (1991); Diamond et al., “Airway epithelial cells are the site of expression of a mammalian antimicrobial peptide gene,” Proc. Natl. Acad. Sci. USA, vol. 90, pp. 4596ff (1993); Selsted et al., “Purification, primary structures and antibacterial activities of β-defensins, a new family of antimicrobial peptides from bovine neutrophils,” J. Biol. Chem., vol. 268, pp. 6641 ff (1993); Tang et al., “Characterization of the disulfide motif in BNBD-12, an antimicrobial β-defensin peptide from bovine neutrophils,” J. Biol. Chem., vol. 268, pp. 6649ff (1993); Lehrer et al., Blood, vol. 76, pp. 2169-2181 (1990); Ganz et al., Sem. Resp. Infect. I., pp. 107-117 (1986); Kagan et al., Proc. Natl. Acad. Sci. USA, vol. 87, pp. 210-214 (1990); Wade et al., Proc. Natl. Acad. Sci. USA, vol. 87, pp. 4761-4765 (1990); Romeo et al., J. Biol. Chem., vol. 263, pp. 9573-9575 (1988); Jaynes et al., “Therapeutic Antimicrobial Polypeptides, Their Use and Methods for Preparation,” WO 89/00199 (1989); Jaynes, “Lytic Peptides, Use for Growth, Infection and Cancer,” WO 90/12866 (1990); Berkowitz, “Prophylaxis and Treatment of Adverse Oral Conditions with Biologically Active Peptides,” WO 93/01723 (1993).

Families of naturally-occurring lytic peptides include the cecropins, the defensins, the sarcotoxins, the melittins, and the magainins. Boman and coworkers in Sweden performed the original work on the humoral defense system of Hyalophora cecropia, the giant silk moth, to protect itself from bacterial infection. See Hultmark et al., “Insect immunity. Purification of three inducible bactericidal proteins from hemolymph of immunized pupae of Hyalophora cecropia,” Eur. J. Biochem., vol. 106, pp. 7-16 (1980); and Hultmark et al., “Insect immunity. Isolation and structure of cecropin D. and four minor antibacterial components from cecropia pupae,” Eur. J. Biochem., vol. 127, pp. 207-217 (1982).

Infection in H. cecropia induces the synthesis of specialized proteins capable of disrupting bacterial cell membranes, resulting in lysis and cell death. Among these specialized proteins are those known collectively as cecropins. The principal cecropins—cecropin A, cecropin B, and cecropin D—are small, highly homologous, basic peptides. In collaboration with Merrifield, Boman's group showed that the amino-terminal half of the various cecropins contains a sequence that will form an amphipathic alpha-helix. Andrequ et al., “N-terminal analogues of cecropin A: synthesis, antibacterial activity, and conformational properties,” Biochem., vol. 24, pp. 1683-1688 (1985). The carboxy-terminal half of the peptide comprises a hydrophobic tail. See also Boman et al., “Cell-free immunity in Cecropia,” Eur. J. Biochem., vol. 201, pp. 23-31 (1991).

A cecropin-like peptide has been isolated from porcine intestine. Lee et al., “Antibacterial peptides from pig intestine: isolation of a mammalian cecropin,” Proc. Natl. Acad. Sci. USA, vol. 86, pp. 9159-9162 (1989).

Cecropin peptides have been observed to kill a number of animal pathogens other than bacteria. See Jaynes et al., “In Vitro Cytocidal Effect of Novel Lytic Peptides on Plasmodium falciparum and Trypanosoma cruzi,” FASEB, 2878-2883 (1988); Arrowood et al., “Hemolytic properties of lytic peptides active against the sporozoites of Cryptosporidium parvum,” J. Protozool., vol. 38, No. 6, pp. 161S-163S (1991); and Arrowood et al., “In vitro activities of lytic peptides against the sporozoites of Cryptosporidium parvum,” Antimicrob. Agents Chemother., vol. 35, pp. 224-227 (1991). However, normal mammalian cells do not appear to be adversely affected by cecropins, even at high concentrations. See Jaynes et al., “In vitro effect of lytic peptides on normal and transformed mammalian cell lines,” Peptide Research, vol. 2, No. 2, pp. 1-5 (1989); and Reed et al., “Enhanced in vitro growth of murine fibroblast cells and preimplantation embryos cultured in medium supplemented with an amphipathic peptide,” Mol. Reprod. Devel., vol. 31, No. 2, pp. 106-113 (1992).

Defensins, originally found in mammals, are small peptides containing six to eight cysteine residues. Ganz et al., “Defensins natural peptide antibiotics of human neutrophils,” J. Clin. Invest., vol. 76, pp. 1427-1435 (1985). Extracts from normal human neutrophils contain three defensin peptides: human neutrophil peptides HNP-1, HNP-2, and HNP-3. Defensin peptides have also been described in insects and higher plants. Dimarcq et al., “Insect immunity: expression of the two major inducible antibacterial peptides, defensin and diptericin, in Phormia terranvae,” EMBO J., vol. 9, pp. 2507-2515 (1990); Fisher et al., Proc. Natl. Acad. Sci. USA, vol. 84, pp. 3628-3632 (1987).

Slightly larger peptides called sarcotoxins have been purified from the fleshfly Sarcophaga peregrina. Okada et al., “Primary structure of sarcotoxin I, an antibacterial protein induced in the hemolymph of Sarcophaga peregrina (flesh fly) larvae,” J. Biol. Chem., vol. 260, pp. 7174-7177 (1985). Although highly divergent from the cecropins and defensins, the sarcotoxins presumably have a similar antibiotic function.

Other lytic peptides have been found in amphibians. Gibson and collaborators isolated two peptides from the African clawed frog, Xenopus laevis, peptides which they named PGS and Gly¹⁰Lys²²PGS. Gibson et al., “Novel peptide fragments originating from PGLa and the caervlein and xenopsin precursors from Xenopus laevis,” J. Biol. Chem., vol. 261, pp. 5341-5349 (1986); and Givannini et al., “Biosynthesis and degradation of peptides derived from Xenopus laevis prohormones,” Biochem. J., vol. 243, pp. 113-120 (1987). Zasloff showed that the Xenopus-derived peptides have antimicrobial activity, and renamed them magainins. Zasloff, “Magainins, a class of antimicrobial peptides from Xenopus skin: isolation, characterization of two active forms, and partial DNA sequence of a precursor,” Proc. Natl. Acad. Sci. USA, vol. 84, pp. 3628-3632 (1987).

Synthesis of nonhomologous analogs of different classes of lytic peptides has been reported to reveal that a positively charged, amphipathic sequence containing at least 20 amino acids appeared to be a requirement for lytic activity in some classes of peptides. Shiba et al., “Structure-activity relationship of Lepidopteran, a self-defense peptide of Bombyx more,” Tetrahedron, vol. 44, No. 3, pp. 787-803 (1988). Other work has shown that smaller peptides can also be lytic. See McLaughlin et al., cited below.

Cecropins have been shown to target pathogens or compromised cells selectively, without affecting normal host cells. The synthetic lytic peptide known as S-1 (or Shiva 1) has been shown to destroy intracellular Brucella abortus-, Trypanosoma cruzi-, Cryptosporidium parvum-, and infectious bovine herpes virus I (IBR)-infected host cells, with little or no toxic effects on noninfected mammalian cells. See Jaynes et al., “In vitro effect of lytic peptides on normal and transformed mammalian cell lines,” Peptide Research, vol. 2, No. 2, pp. 1-5 (1989); Wood et al., “Toxicity of a Novel Antimicrobial Agent to Cattle and Hamster cells In vitro,” Proc. Ann. Amer. Soc. Anim. Sci., Utah State University, Logan, Utah. J. Anim. Sci. (Suppl. 1), vol. 65, p. 380 (1987); Arrowood et al., “Hemolytic properties of lytic peptides active against the sporozoites of Cryptosporidium parvum,” J. Protozool., vol. 38, No. 6, pp. 161S-163S (1991); Arrowood et al., “In vitro activities of lytic peptides against the sporozoites of Cryptosporidium parvum,” Antimicrob. Agents Chemother., vol. 35, pp. 224-227 (1991); and Reed et al., “Enhanced in vitro growth of murine fibroblast cells and preimplantation embryos cultured in medium supplemented with an amphipathic peptide,” Mol. Reprod. Devel., vol. 31, No. 2, pp. 106-113 (1992).

Morvan et al., “In vitro activity of the antimicrobial peptide magainin 1 against Bonamia ostreae, the intrahemocytic parasite of the flat oyster Ostrea edulis,” Mol. Mar. Biol., vol. 3, pp. 327-333 (1994) reports the in vitro use of a magainin to selectively reduce the viability of the parasite Bonamia ostreae at doses that did not affect cells of the flat oyster Ostrea edulis.

Also of interest are the synthetic peptides disclosed in U.S. Pat. Nos. 6,566,334 and 5,789,542, peptides that have lytic activity with as few as 10-14 amino acid residues.

The complete disclosures of all references cited in this specification are hereby incorporated by reference, including without limitation the complete disclosure of priority application 60/938,502. In the event of an otherwise irreconcilable conflict, however, the present specification shall control.

What is claimed:

1. A method for delivering a peptide toxin to a colonial or social insect population, said method comprising feeding one or more individuals from the insect population live yeast or a bait containing live yeast; wherein the yeast comprises at least one exogenous DNA sequence encoding at least one peptide toxin, wherein the DNA sequence is operatively linked to a constitutive promoter or an inducible promoter; wherein the peptide toxin is lethal to some or all cells selected from the group consisting of native protozoal symbionts of the insect gut, native bacterial symbionts of the insect gut, and cells of the insect gut itself.

2. The method of claim 1, wherein the yeast is Kluyveromyces lactis.

3. The method of claim 1, wherein the peptide toxin is a lytic peptide.

4. The method of claim 1, wherein the insect population is a population of termites or cockroaches.

5. The method of claim 1, wherein the insect population is a population of termites.

6. The method of claim 1, wherein the insect population is a population of Formosan subterranean termites.

7. The method of claim 1, additionally comprising the step of allowing the yeast to be distributed throughout the insect population by trophallaxis, grooming, or other social interactions among members of the insect population.

8. The method of claim 7, wherein the DNA sequence is operatively linked to an inducible promoter; wherein the inducible promoter is not effectively induced in response to any composition that normally occurs in significant concentration in the vicinity of the insect population; and wherein the method additionally comprises the step, after the yeast has become distributed throughout the insect population, of administering to the insect population an inducer to which the inducible promoter is responsive; whereby substantial expression of the peptide toxin occurs only after the inducer has been administered.

9. The method of claim 1, wherein the method kills substantially all members of at least one species of protozoal symbiont in the insect population.

10. The method of claim 1, wherein the method kills substantially all members of at least one species of bacterial symbiont in the insect population.

11. The method of claim 1, wherein the method kills substantially all members of the insect population.

12. A composition of matter comprising a cellulosic bait upon which termites or cockroaches will feed; and further comprising live yeast; wherein the yeast comprises at least one exogenous DNA sequence encoding at least one peptide toxin, wherein the DNA sequence is operatively linked to a constitutive promoter or an inducible promoter; wherein the peptide toxin is lethal to some or all cells selected from the group consisting of native protozoal symbionts of the insect gut, native bacterial symbionts of the insect gut, and cells of the insect gut itself.

13. The composition of claim 12, wherein the yeast is Kluyveromyces lactis.

14. The composition of claim 12, wherein the peptide toxin is a lytic peptide.

15. The composition of claim 12, wherein the DNA sequence is operatively linked to an inducible promoter; wherein said inducible promoter is not effectively induced in response to any composition that normally occurs in significant concentration in the vicinity of the insect population.

16. A kit comprising the first composition and a second composition; wherein said first composition is a composition as recited in claim 15; and wherein said second composition comprises an inducer to which said inducible promoter is responsive; and wherein said first and second compositions are packaged separately within said kit.


SEQUENCE LISTING (6 sequences)

SEQ ID NO: 1 - protein, 22 aa, Artificial Sequence
  This is the designed peptide known as hecate.
FALALKALKKALKKLKKALKKA

SEQ ID NO: 2 - DNA, 69 bp, Artificial Sequence
  This is a codon-optimized sequence for the designed peptide known as hecate.
tttgctttggctttgaaggctttgaagaaagcattgaaaaagttgaaaaaggctctgaaaaaggcttta

SEQ ID NO: 3 - DNA, 12 bp, Artificial Sequence
  Additional DNA sequence added to 5′ end of coding sequence for the designed peptide known as hecate.
ctcgagaaaaga

SEQ ID NO: 4 - DNA, 12 bp, Artificial Sequence
  Additional DNA sequence added to 3′ end of coding sequence for the designed peptide known as hecate.
taaagatctcgc

SEQ ID NO: 5 - DNA, 96 bp, Artificial Sequence
  Coding sequence for the designed peptide known as hecate.
cgcctcgagaaaagatttgctttggctttgaaggctttgaagaaagcattgaaaaagttgaaaaaggctctgaaaaaggctttataaagatctcgc

SEQ ID NO: 6 - DNA, 810 bp, Artificial Sequence
  Coding sequence for a fusion of the designed peptide known as hecate with green fluorescent protein.
cgcctcgagaaaagatttgcgctggctctgaaagcgctgaaaaaagcactgaaaaaactgaaaaaagccctgaaaaaggctctgatgagcaaaggtgaagaactgttcacaggggtggttccgattctggtggaactggatggcgatgtgaacggtcataaatttagcgttagcggtgaaggtgaaggcgacgcgacatacggcaaactgacactgaagtttatttgcacgaccggcaaactgccagttccgtggccaacactggtcacgacatttggttacggcgtacagtgcttcgcgcgttatcctgaccatatgaaacagcatgatttctttaaaagtgctatgcctgagggttatgtgcaggaacgtaccattttctttaaagacgacggtaactataaaacccgtgcggaagtcaaattcgagggtgatacgctggttaaccgcattgaactgaaaggaattgatttcaaagaagatggcaatattctgggtcacaaactggagtataattataacagccataatgtttatattatggcagataaacagaaaaacggtatcaaagtgaacttcaaaattcgtcacaacatcgaagatgggtcagtgcagctggcagatcattatcagcagaacacgccaattggcgacggcccggtcctgctgcctgataaccattatctgtctactcagagcgcgctgagcaaagatcctaatgaaaaacgcgatcatatggtcctgctggaatttgtcaccgccgcaggcattacacacggcatggatgaactgtacaaataaagatctcgc